(19) United States
(12) Patent Application Publication
(10) Pub. No.: US 2003/0012853 A1
(43) Pub. Date: Jan. 16, 2003

(54) Sweet and salty microwave popcorn compositions; arrangements and method

(76) Inventors: Michael Laurence Jensen, Spring Lake Park, MN (US); Lance Bernard Schilmoeller, Minnetonka, MN (US); Lisa Marie Schmidt, Waconia, MN (US)

Correspondence Address: MERCHANT & GOULD PC, P.O. BOX 2903, MINNEAPOLIS, MN, 55402-0903, US

(21) Appl. No.: 10/094,294

(22) Filed: Mar. 8, 2002

Related U.S. Application Data
(63) Continuation-in-part of application No. 09/795,571, filed on Feb. 28, 2001.

(51) Int. Cl. A23B 4/00

(52) U.S. Cl. 426/107

(57) ABSTRACT

A sweet and salty microwave popcorn composition is provided. The sweet taste is provided by using a sweetening effective amount of sucralose in the composition. The salt taste is provided by using an effective amount of sodium chloride or common salt. Various sugar components (monosaccharides and non-sucralose disaccharides) are preferably avoided, to accomplish a desirable taste without burn. Microwave popcorn products using compositions as characterized, and preferred methods, are also provided.

This application is a continuation-in-part application of U.S. patent application serial no. 09/795,571 filed February 28, 2001. The entire disclosure of U.S. Pat. No. 09/795,571 is incorporated herein by reference.

### FIELD OF THE INVENTION

The present invention relates to microwave popcorn. The invention particularly concerns methods and compositions for flavoring microwave popcorn to achieve a sweet and salty flavor.

Background of the Invention Microwaveable popcorn (sometimes referred to as microwave popcorn) is a popular consumer item. In general, the form of product obtained by the consumer includes an unpopped popcorn composition enclosed within a disposable container, such as a paper container or fiber board (or paper board) container. In many instances, microwave susceptors (microwave interactive constructions) are provided on or within the container to facilitate collection of microwave energy and heat transfer to the popcorn composition during popping. The product is typically used by placing the disposable container, with the unpopped popcorn therein, inside a microwave oven. After exposure to microwave energy in a conventional microwave oven for about 1-5 minutes, typically about 95% of the popcorn converts to its popped form. Microwave popcorn arrangements for use in this manner are described, for example, in U.S. Pat. No. 5,044,777; 4,548,826; 4,691,374; 4,450,180; 5,650,084; 5,008,024; 5,834,046 and 5,097,107; the disclosures of these patents being incorporated herein by reference.

Many consumers prefer their microwave popcorn to be flavored. A desirable manner to provide a flavor is to include appropriate flavoring materials within the popcorn composition before popping, so that, as popped, the microwave popcorn is provided with the desired taste, without necessity of an added post-pop flavoring step. For example, a salty taste can be provided by including appropriate levels of a salt, typically sodium chloride (NaCl), in the microwave popcorn composition. The following commercial microwave products, available from Golden Valley Microwave Foods of Eden Prairie, Minnesota, are examples of products that currently provide significant salt taste when popped: “Act II Natural Microwave” and “Act II Butter Microwave Popcorn.” This salted taste is a result of including sodium chloride in the microwave composition contained within the product enclosure prior to popping. Microwave popcorn formulations that use sodium chloride to provide a salty taste are described in the following U.S. patents, incorporated herein by reference: U.S. Pat. Nos. 5,585,127; 5,750,166; 5,993,869; and 6,083,552.

Some consumers enjoy a sweet flavor to their microwave popcorn. One method of providing a sweet flavor in the microwave popcorn is to include a sweetener within the microwave popcorn composition prior to popping. A problem with this approach is that sweeteners are often susceptible to undesirable levels of burning during the microwave popping operation, thus providing an undesirable taste. This problem is discussed, for example, in U.S. Pat. No. 5,443,858, the complete disclosure of which is incorporated herein by reference.

There are also consumers that enjoy the combination of the two flavors: i.e., a sweet and salty, or salty and sweet, taste. Examples of common sweet and salty foods include chocolate covered peanuts, sugar frosted or chocolate covered pretzels, and honey roasted peanuts. It would be desirable to develop an acceptable sweet and salty microwave popcorn product.

### SUMMARY

Microwaveable popcorn compositions are provided. The popcorn compositions are such that upon popping each provides a popcorn product having an acceptable sweet and salty taste. By the term “acceptable” in this context, it is meant that a sweet and salty taste is developed, without an unacceptable level of burned or bitter taste.

I. Preferred Formulations As Characterized in the patent application, U.S. Pat. No. 09/795,571 filed Feb. 28, 2001.

The composition of U.S. Pat. No. 09/795,571, in general, comprises unpopped popcorn, an oil/fat component, at least an amount of salt effective to provide a desirable salty flavor, and at least a sweetening effective amount of sucralose. The term “sweetening effective amount” in this context, is meant to refer to an amount of sucralose adequate so that a detectable sweet component is provided to the overall flavor of the product. Thus, in combination with the salt, a sweet and salty taste is provided by the sucralose.

A typical preferred composition according to the parent disclosure includes 64-70% unpopped popcorn, 29-33% oil, 0.9-1.8% salt (typically sodium chloride) and 0.02-0.2% sucralose, all by weight percent of the total unpopped popcorn composition.

According to the parent disclosure, preferably the composition includes: less than 2% monosaccharides (more preferably less than 1% monosaccarides), less than 2% disaccharides not including sucralose (more preferably less than 1% of such sugars), and less than 2% corn syrup solids (more preferably less than 1% corn syrup solids). Preferably, the total amount of added monosaccharides, disaccharides other than sucralose, and corn syrup solids in the composition is minimal (e.g., less than 1%), and, if these components are present at all, they are in a minimum effective amount to provide any desirable flavor modifications.

According to the parent disclosure, a preferred microwave popcorn product is provided which comprises a container suitable for use in a microwave popping process, with a microwave popcorn composition as characterized above provided inside the container, in thermoconductive relation to a microwave interactive construction. The term “microwave interactive construction” in this context is meant to refer to a material which, (upon exposure to microwave energy) becomes heated and thus can transfer heat to the microwave popcorn composition. Typical microwave interactive compositions comprise metallized substrates, for example an aluminized or metalicized polymer sheet. The term “thermoconductive relation” is meant to refer to a proximity close enough so that when exposed to microwave energy, heat generated by the microwave interactive construction is detected in the region where the popcorn composition resides.

The container may be; for example, a flexible paper bag, such as a two- ply bag, having a microwave interactive construction mounted on or in the bag. Alternatively, the package may be a fiberboard tub, having a microwave susceptor positioned on or inside the tub.

According to the parent disclosure, a method for preparing a sweet and salty popcorn food is provided. The method, in general, comprises a step of popping a preferred popcorn composition, as characterized herein, by microwave treatment or microwave heating. The terms “microwave treatment” and “microwave heating” in this context are meant to refer to a popping operation which concerns exposure of the microwave popcorn composition to microwave energy in a microwave oven and is meant to include within its scope such an exposure while the microwave popcorn composition is in thermoconductive contact with a microwave susceptor.

II. A Reduced Fat Alternative According to the Present Disclosure.

An improvement in the formulations characterized in U.S. Pat. No. 09/795,571 is provided herein, in the form of lower fat alternative formulations, to accomplish a sweet and salty flavor in a lower fat or low fat composition. In general, as with the parent, the key flavor components of the composition are: unpopped popcorn kernels; salt; and, sucralose as a sweetner. In the detailed description below, the preferred ratios, by wt., of: sucralose to salt; salt to popcorn; and, sucralose to popcorn, are provided. In some instances ratios similar to those of the parent application can be used. In the current preferred formulations compositions including less fat, by wt., than the preferred formulations of the parent application, are provided. As with the preferred compositions characterized in the parent application, preferably formulations, according to the reduced fat formulations include: less than 2% and more preferably less than 1 wt-%. percent monosaccharides, if any; less than 2 wt-%, and more preferably 1 wt-% non-sucralose disaccharides, if any; and, less than 2 wt-%, and more preferably less than 1 wt-% corn syrup solids, if any. Most preferably the compositions include no added monosaccharides, no added non-sucralose sugars, and no added corn syrup solids.

### BRIEF DESCRIPTION OF THE DRAWINGS

FIG. 1 is a front perspective view of an arrangement incorporating a microwave popcorn composition according to the present disclosure; the arrangement of FIG. 1 being depicted closed in a storage overwrap and oriented standing on an edge.

FIG. 2 is the schematic top plan view of an arrangement according to FIG. 1, depicted unwrapped and unfolded, as it would be when positioned in a microwave oven for cooking.

FIG. 3 is a front perspective view generally analogous to FIG. 1, with portions broken away to show internal detail and without the overwrap.

FIG. 4 is a cross-sectional view taken generally along line 4-4, FIG. 2.

FIG. 5 is a schematic, plan view of a package blank showing an adhesive pattern useable to generate a bag useable in the arrangement of FIGS. 1-4.

FIG. 6 is a schematic cross-sectional view of a fiberboard tub including a microwave popcorn composition according to the present disclosure.

### DETAILED DESCRIPTION

I. The Detailed Disclosure of the Parent Application U.S. Pat. No. 09/795,571.

As indicated above, the parent application (i.e., U.S. Pat. No. 09/795,571) relates to microwave popcorn. The parent disclosure concerns a popcorn composition suitable for microwave popping, which includes, in addition to the popcorn, appropriate agents to provide the eventual product with a desirable sweet and salty taste, even in the absence of additional “post-pop additive(s)”. Herein the term “post-pop additive(s)” and variants thereof, is meant to refer to flavorants or other adjuvants added after the popping process is completed. The parent disclosure, then, concerns providing a preflavored microwaveable popcorn composition, which can then be popped to provide a desirable sweet and salty flavor in the final product.

By the phrase “even in the absence of additional ‘post-pop additive(s)”’ it is not meant that the compositions cannot be used in association with post-pop additives. Rather, it is meant that, at least with respect to the tastes of the general population, a sweet and salty taste will be provided by the compositions without the requirement of additional post-pop additives.

In the past, provision of a sweet flavor in microwave popcorn (prior to popping) has raised significant difficulties. The difficulties generally concern undesirable burn or burned taste resulting from burning of the sugars present in sweetened flavorings as the popcorn is popped in the microwave system. This problem is described in U.S. Pat. No. 5,443,858, incorporated herein by reference. In the ′858 patent, the problem was addressed by providing a unique flavor composition which, among other things, preferably contained no more than 200 mg. of sodium chloride (salt) per 100 grams of glazing blend, most preferably no more than 140 mg per 100 grams of glazing blend. The term “glazing blend” as used in the ′858 patent, referred to all components in the popcorn composition other than the popcorn itself. Thus, the amount of salt acceptable in the popcorn compositions of that reference was very low.

According to the parent disclosure, in order to obtain an acceptable salty taste, it is generally necessary to provide a level of at least 0.5 gram salt per 66 grams popcorn (unpopped), typically at least 0.8 gram salt per 66 grams popcorn (unpopped); and preferably about 0.9-1.8 grams salt per 66 grams popcorn (unpopped). This amount of salt in the composition is too high to use the techniques of the ′858 patent to obtain a sweet flavoring, without unacceptable levels of burn. According to the ′858 patent, column 4, lines 51-62, to avoid undesirable burn, it is necessary to minimize the amount of salt (sodium chloride) when the flavoring composition includes sweeteners. It has been theorized that the burn generally results from dissociation of the sodium chloride in the presence of moisture in the system, with resulting hot spots generated in the microwave field. See Microwave Foods: New Product Development, by R.V. Decareau, 1992, pp. 48-50, incorporated herein by reference.

It has been found that a desirable sweet and salty taste composition, which does not lead to undesirable levels of burn in a typical microwave popping operation, can be obtained by using of particular sweetening agents in defined levels, and preferably in a composition that minimizes, and most preferably excludes, the presence of other types of sweeteners. A particular sweetening agent useable to provide the sweet flavor in sweet and salty compositions according to the parent disclosure is 1,6-dichloro-1,6-dideoxy-β-D-fructofuranosyl-4-chloro-4-deoxy-α-D-galactopyranoside, generally known as sucralose. Kirk-Othmer's Encyclopedia of Chemical Technology, fourth edition, alternately defines sucralose as 4,1′,6′-trichloro-4,1′,6′-trideoxygalactosucrose. A still further name is 1′,4,6′-trichloro-rogalatosucrose. The sweetener is also described in European patent application 87308260.6 (publication No. 0 260 979) filed Sept. 17, 1987 and published Mar. 23, 1988. One commercially available sucralose is SPLENDA® brand sweetener powder from McNeil Specialty Products Company.

Sucralose is similar to common sugar, in that it is a generally white, crystalline powder and practically odor free. However, sucralose has about 450 to 650 times the sweetness of sugar (i.e., sucrose), yet is said to add no calories to the food product. The molecular formula is C₁₂Hl₉Cl₃O₈ and it has a molecular weight of about 398. The commercial product available as usable sucralose will typically be at least 98% sucralose, more typically at least 99% sucralose, the remainder being residuals left from the manufacturing process or other trace impurities.

Sucralose is preferred for the sweetening agent because it has been found that various monosaccharides (galactose, fructose (levulose), glucose (dextrose), and dextrose derivatives, for example) and disaccharides (such as sucrose, maltose, lactose and cellobiose) have a significant tendency to burn in microwave popcorn systems, especially in the presence of significant amounts of salt.

It is understood that sucralose may be classified as a disaccharide because of its molecular structure. For this application, it is intended that sucralose is not included in the disaccharide family of sugars. Thus, where the term “disaccharide” or “disaccharides” is used, this is intended to not include sucralose. In some instances in this application, the terms “non-sucralose disaccharide”, “disaccharides not including sucralose”, or variations thereof may be used to emphasize that sucralose is not considered a disaccharide for this application.

In general, for compositions according to the techniques of the parent disclosure, the disaccharide levels (not including sucralose) should be limited to no more than about 2 wt-% of the total popcorn composition (popcorn plus flavor ingredients and oil/fat), typically no more than about 1 wt-%. The presence of monosaccharides (for example, the various dextrins such as maltodextrin) should also be limited to no more than about 2 wt-%, typically no more than about 1 wt-%, of the total microwave popcorn composition.

In general, for preferred compositions according to the techniques of the parent disclosure, it is preferred that non-sucralose disaccharide levels are no more than about 0.6 wt-% of the total popcorn composition, and that the monosaccharide levels are no more than about 0.6 wt-%, of the total microwave popcorn composition. Preferably, the total of non-sucralose disaccharides and monosaccharides is less than about 1 wt-% of the total popcorn composition, even more preferably less than about 0.5%, and most preferably, there are no added disaccharides (not including sucralose) and/or monosaccharides.

Corn syrup solids are another sweetener that has a tendency to burn in the presence of salt. Corn syrup solids are produced from a process in which corn starch, or another starch, is hydrolyzed. “Dextrose equivalent” or DE values are a measure of the product's reducing power as a percentage of the reducing power of pure dextrose (D-glucose). Acid hydrolysis of corn starch takes place to a DE level of about 42 and, if a higher DE value is required, the hydrolysis is continued with enzymes. Corn syrup solids have a DE starting at about 20 DE; as the DE increases, the molecular weight decreases until the starch is broken down to pure glucose or dextrose, which has a dextrose equivalent of 100 DE. Preferably, according to the parent disclosure, the total corn syrup solids content in the popcorn composition is no greater than about 2 wt-% of the total composition, typically less than 1 wt-%, more preferably less than 0.6 wt-%, even more preferably less than 0.5 wt-%, and most preferably, is zero.

In general, the negative effects of burn are additive; that is, if enough components are present, each component which alone is not enough to provide an undesirable level of burn taste, the user may nevertheless taste undesirable burn in the product as a result of the sum of the various components. As a result, it is preferred that the total amount of natural sweeteners, which includes monosaccharides, non-sucralose disaccharides, corn syrup solids, and maltodextrin, present in the popcorn composition is less than 1 wt-%, more preferably less than about 0.5 wt-%, and preferably zero.

The following table provides a definition of preferred compositions according to the parent disclosure.

Preferred Formulations for Sweet and Salty Microwave Popcorn

| | | | Typical | | |
|---|---|---|---|---|---|
| | | | Wt-%¹ in | | |
| | | | Preferred | | |
| | Typical | Preferred | Compo- | Example | |
| Ingredient | Wt-%¹ | Wt-%¹ | sition | grams/bag⁴ | |
| Unpopped | >55 wt-%, | 64-70 wt-% | 66 wt-% | 66.00 | g |
| Popcorn | typically | | | | |
| | >60 wt-% | | | | |
| Oil/Fat | >25 wt-%, | 29-33 wt-% | 31.5-32.5 | 31.96 | g |
| | typically 27- | | wt-% | | |
| | 35 wt-% | | | | |
| Salt (NaCl) | ≧0.8 wt-% | 0.9-1.8 | 1 wt-% | 1.0 | g |
| | and ≦2 wt-% | wt-% | | | |
| Sucralose | ≧0.01 wt-% | 0.02-0.2 | 0.03-0.05 | 0.040 | g |
| | and <0.5 wt-% | wt-% | wt-% | | |
| Mono- | <2 wt-% | <1 wt-% | 0.0 | 0.000 | g |
| saccharides² | | | | | |
| Sugar³ | <2 wt-% | <1 wt-% | 0.0 | 0.000 | g |
| Corn Syrup | <2 wt-% | <1 wt-% | 0.0 | 0.000 | g |
| Solids | | | | | |
| | | | | Total: 99 | g |

¹Based on total weight of unpopped popcorn composition, including popcorn, oil/fat, and flavor additives.
²The term “monosaccharides” includes dextrin and dextrin derivatives such as maltodextrin.
³The term “sugar” means disaccharides (other than sucralose).
⁴A 99 gram composition, having 66 grams of unpopped popcorn, is a typical single microwave popcorn bag.

The term “oil/fat” and variants thereof refer to materials that are primarily tri-fatty acid esters of glycerol. Fat is a natural lipid material that is mainly solid at room temperature. Oil is a similar to fat, but is liquid at room temperature. The term “oil/fat component” is meant to refer to oil(s), fat(s) (natural or modified) and any mixtures thereof. The “oil/fat component” may be a solid, liquid, or semi-solid at room temperature.

Also according to the parent disclosure, an overall microwave popcorn product is provided which includes an unpopped popcorn composition generally in accord with the above characterizations, in combination with a container system for popping the popcorn in a microwave oven. In general, such container systems include a microwave popcorn package of some type, for example a bag in accord with U.S. Pat. No. 5,690,084 or a tub in accord with U.S. Pat. Nos. 5,008,024 or 5,834,046, with the microwave popcorn composition appropriately positioned therein. In typical preferred systems, the microwave container contains a microwave interactive construction or susceptor, to enhance the popping operation. Such susceptors are described for example in U.S. Pat. Nos. 5,149,396; 5,175,031; 5,338,911; and 5,285,040, all incorporated herein by reference.

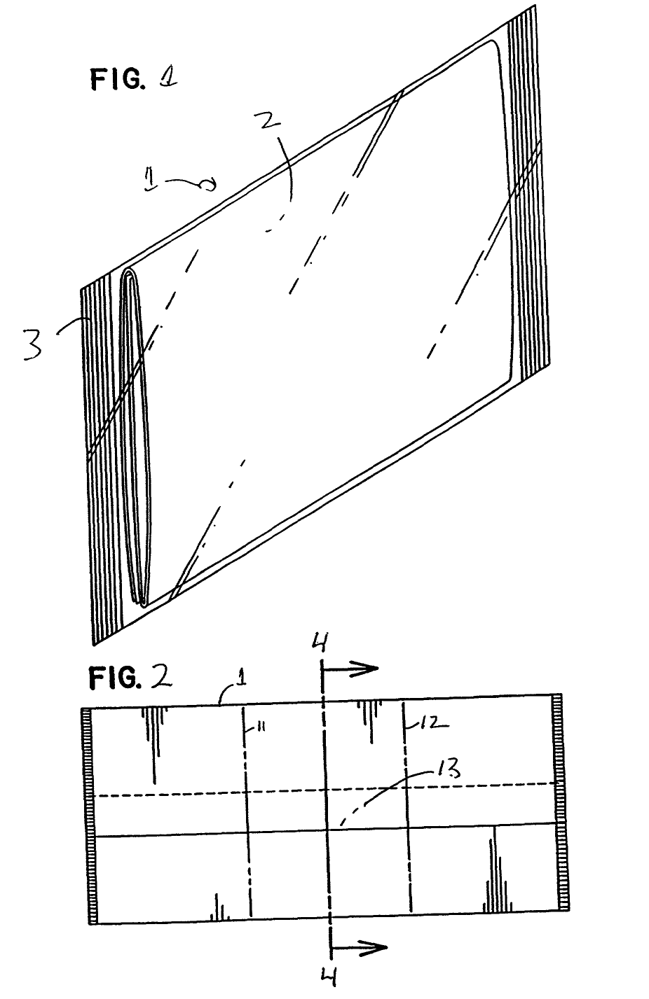

Attention is now directed to FIG. 1. In FIG. 1 a microwave popcorn package 1 is depicted stored or oriented substantially vertically. The package 1 is depicted in a trifold configuration 2, included with an overwrap 3 for storage.

In FIG. 2, a top plan view of popcorn package 1 is shown schematically in an unfolded configuration and oriented much as it would be when positioned in a microwave oven for popping of the popcorn charge contained therein, but before expansion of the package. In FIG. 2, lines 11 and 12 indicate fold lines which define central region 13 of the arrangement. Inside the bag in the central region 13, the unpopped popcorn charge or composition would generally be positioned in orientation above a portion of the bag in which a microwave interactive construction is positioned. The term “microwave interactive” is meant to refer to a material that becomes hot upon exposure to microwave energy in a microwave oven. Typical microwave interactive constructions comprise a metallized polymeric component (for example, aluminized products) positioned in the package 1.

During the popping operation, moisture inside the popcorn kernels absorbs microwave energy, generating sufficient steam and heat for popping and for expansion of the bag 1. In addition, the microwave interactive material also absorbs microwave energy and dissipates heat to the popcorn charge. In preferred constructions, the microwave interactive material occupies at least central region 13. This increases the thermoconductive contact between the popcorn charge and the microwave interactive material, which is preferred, since it leads to efficient utilization of the microwave interactive material and to preferred heat transfer and heat retention characteristics in connection with the popcorn popping process.

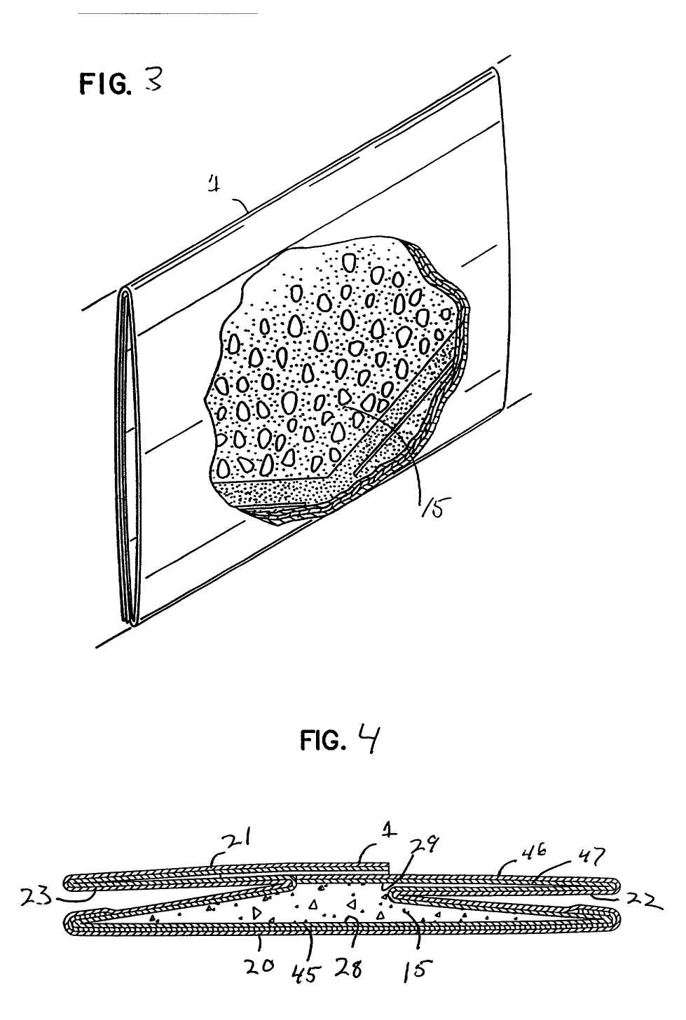

In FIG. 3, package 1 is shown removed from the overwrap 3, but not unfolded. Portions are shown broken away, to show where a popcorn charge or popcorn composition 15 is internally received. The terms “popcorn charge”, or “popcorn composition” or variants thereof are meant to refer to the unpopped popcorn kernels, any oil/fat used, and any edible adjuvants or additives, for example sweeteners, salt and other flavorants. In other words, the terms refer to the food components placed into package 1, prior to popping.

Attention is now directed to FIG. 4, a cross-section taken generally along line 4-4, FIG. 2. From a review of FIG. 4, it will be understood that the popcorn package 1 generally comprises a double wall (or two-ply) configuration defining first and second opposite panels 20 and 21 joined by first and second side gussets 22 and 23.

Gussets 22 and 23 generally separate popcorn package 1 into first and second expandable tubes 28 and 29. Popcorn charge 15 is substantially positioned and substantially retained within tube 28. Tube 29, prior to popping, is generally collapsed. Indeed, in preferred arrangements tube 29 is sealed closed by temporary heat seals, prior to popping.

Underneath popcorn charge 15, package 1 includes a microwave interactive construction or susceptor 45. The microwave interactive construction or susceptor 45 may be of conventional design. In certain arrangements, such as the one shown in FIG. 4, susceptor 45 is positioned between two plys (46, 47) from which flexible package 1 is folded.

In FIG. 5, a panel 60 is shown; panel 60 is a blank or sheet of flexible material from which package 1 is folded. Panel 60 includes various sealant fields 61 thereon, shown in dot pattern, which provide desired features in the resulting folded package 1. The function of such sealant fields 61, to provide a desirable microwave product, is described in U.S. Pat. No. 5,650,084, incorporated by reference.

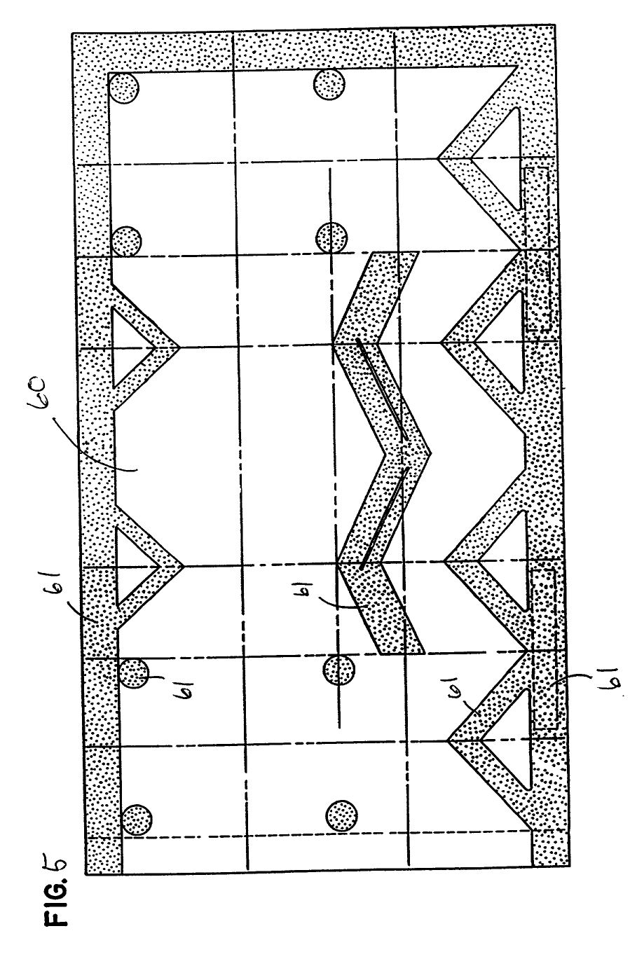

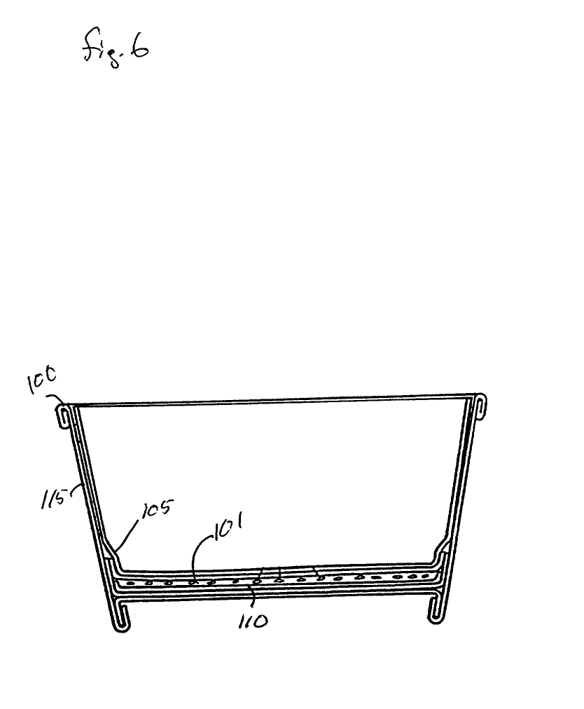

In alternate embodiments, microwave popcorn compositions according to the parent disclosure can be utilized in tub configurations, as for example shown schematically in FIG. 6 and characterized in U.S. Pat. No. 5,384,024, incorporated herein by reference. A cross-section of such a tub 100 is depicted in FIG. 6, containing popcorn charge 101. Popcorn charge 101 is positioned in proximity to a microwave interactive construction 110. Such tubs are generally made from a paperboard or fiberboard material, with a flexible film used for a cover. In general, with such arrangements, a cover 105 expands or balloons under the heat and steam produced during the popcorn popping operation. Tub 100 has an inverted conical sidewall construction 115 that facilitates nesting and stacking, facilitates popping of charge 101, and provides a bowl after popping and opening/removal of cover 105.

II. Further Observations Regarding Information and/or Formulations Disclosed in U.S. Pat. No. 09/795, 571 Filed Feb. 28, 2001.

In the parent disclosure, U.S. Pat. No. 09/795,571, in some instances relative amounts of the components were stated as a percent of a total composition including certain identified components. As is apparent from the parent disclosure, the key flavor components with respect to accomplishment of the sweet and salty flavored popcorn, are: the unpopped popcorn kernels; the salt; and, the sucralose sweetener. In addition, key limitations in components to achieve the flavor without unacceptable levels of burn, concern limitations in the amount of: monosaccharides; disaccharides other than sucralose; and, corn syrup solids.

The recommended levels of selected components stated in the parent application can be restated, based on the information provided therein, in terms of relative amounts of these key flavor components to one another, for example as follows.

A. Ratio of Salt to Unpopped Popcorn Kernels.

It is stated in the parent disclosure that preferably the salt is at a level of at least 0.5 grams of salt per 66 grams of unpopped popcorn, typically at least 0.8 grams salt per 66 grams unpopped popcorn, and preferably about 0.9-1.8 grams salt per 66 grams popcorn. This can be alternately stated as a weight ratio (salt/popcorn) of at least 0.0076, typically at least 0.0121 and preferably within the range of 0.0136-0.0273.

The parent application also indicates the that preferably the salt is present in no greater than 2 wt-% of the total composition. Given the statement in the Table that the composition preferably includes greater than 55 wt-% popcorn, this leads to a conclusion that the weight ratio of salt to popcorn will typically be less than 2/55, or less than 0.0364.

Further information concerning preferred salt levels relative to popcorn, is found in the parent application. For example, it is stated that preferably the composition includes greater than 55 wt-% unpopped popcorn kernels (more preferably >60 wt-%), and preferably greater than or equal to 0.8 wt-% salt. This would provide a typical, preferred ratio of salt of greater than or equal to 0.8 grams of salt per (greater than) 60 grams unpopped popcorn; i.e., ratio of preferably>0.0133 (i.e., 0.8/60).

Thus, one can conclude from the parent disclosure that typical salt levels are such as to provide a salt to unpopped popcorn ratio within the range of 0.0121 to 0.0364, typically 0.0133-0.0364. The preferred composition identified in the Table has a ratio of 1/60 or 0.017.

Consistent with the disclosure of the parent, the above is not meant to suggest that all compositions must be within the ranges indicated, only that typical, preferred, ones are.

B. Ratio of Sucralose to Salt.

According to the parent disclosure, preferably the composition includes greater than or equal to 0.8 wt-% salt and less than or equal to 2 wt-% salt; and, the composition includes greater than or equal to 0.01 wt-% sucralose and less than 0.5 wt-% sucralose. In general, this provides a range of weight ratios of sucralose to salt of between 0.01/2 and 0.5/0.8 or between 0.005 and 0.625. According to the parent, the sucralose/salt ratio is preferably between 0.02/1.8 and 0.2/0.9 or between 0.011 and 0.222. The typical ratio of sucralose to salt would, according to the parent, be between 0.03/1 and 0.05/1. Again, consistent with the parent disclosure, it is not meant that all compositions must be within the stated ranges, only that typical, preferred ones, are.

C. Weight Ratio of Sucralose to Unpopped Popcorn.

Typical weight ratios of sucralose to unpopped popcorn, derivable from the information in the parent application, would be within the range of 0.01/60 to 0.5/55 or 0.00017-0.00909. The preferred ranges would be between .02/70 and 0.2/64 or 0.00029-0.00313. The typical ratio would be between 0.03/66 and 0.05/66 or 0.00045-0.00076. Again, it is not meant that all compositions must be within the range stated, only that typical, preferred, ones would be.

D. Typical Salt; Other Flavors; Color.

Another observation concerning sweet and salty microwave popcorn compositions, relates to the nature of the salt used. In general, the specific nature of the salt: i.e., powder vs. granular, is not critical to achievement of the principal objectives according to the present and the parent disclosures, namely: accomplishment of a sweet and salty taste without unacceptable levels of sugar burn. However, the salt flavor impact on the consumer and thus consumer preference may vary, depending on the specific nature of the salt used. In general, it has been observed that a mixture of coarse salt (for example Morton TCF 999) and powdered salt (for example Morton 200) in a ratio of about 1.1 to 1 is preferred by many consumers because of their individual senses of salt flavor impact.

As to the use of flavors in addition to salt and sucralose, the compositions can include a variety of other flavors such as butter flavor, vanilla flavor, sweet butters/creams, cinnamon, fruit flavors, chocolates/cocoas, maples, nut flavors/peanut butter, caramels, molasses, brown sugars, cotton candy, cookie flavors/graham crackers, sweet BBQ's, honeys, marshmallow, butterscotch, toffees, licorice, mints, sweet alcohol flavors, sweet vegetable flavors (e.g., sweet potato, sweet corn), coffee, tea, pop/soda beverage flavors (e.g., cola, root beer, cream soda, etc.), citric flavors, dressing & condiment flavors, dairy flavors (e.g., milk, yogurt, sweet cheeses), ethnic savory/sweet combinations (e.g., sweet chillies).

In general, in selecting additional flavors besides salt and sucralose, particular attention must be given to the content of those flavors, so as to avoid addition of components that will exacerbate the burn problem. Thus, flavors that include significant amounts of disaccharides, monosaccharides or corn syrup solids, should generally be avoided. Typically the additional flavor additives, is used, would be used in a minimum effective amount to provide the desirable flavor sought. Typically such amounts will be so low to not significantly modify the previously stated ranges and preferred ranges for the other key components, as a percent of the total composition. In general, when such additional flavor additives are used, the oil/fat component is reduced, in percent, enough to accommodate the additional compositional weight provided by the flavor.

Colors can be added. Typically they will be used in very low amounts, if at all. Generally, their presence is disregarded herein, as long as they are selected from materials that do not interfere with the flavor components.

E. The Oil/Fat Component.

In general, it should be noted that the oil/fat component provides significant benefit in the product, with respect to such factors as: distributing the flavor over the popcorn well, during the popcorn popping process; and, enhancing mouth feel of the popcorn, for the consumer.

III. Reduced Fat Compositions.

Further investigations regarding the invention of the parent disclosure, have lead to the development of reduced fat versions of the sweet and salty product. In general, reduced fat compositions according to this disclosure are compositions that include no more than about 20 wt-% oil/fat component, preferably no more than about 15 wt-% oil/fat component, based on total weight of the composition.

In general, the preferred reduced fat compositions characterized herein can be used in a manner similar to the compositions characterized previously herein and in the parent application, and in microwave popcorn packages similar to those previously characterized herein and in the parent application. Further, the compositions can be prepared from similar components using similar techniques. In addition, the compositions can be popped using similar techniques and methods.

In general, reduced fat compositions in accord with the present techniques typically include: at least 80 wt-% and not more than 98 wt-% unpopped popcorn kernels; at least 1 wt-% and not more than 15 wt-% oil/fat component; at least 0.5 wt-% and not more than 5 wt-% salt (sodium chloride); and at least 0.01 and not more than 0.5 wt-% sucralose. Also, preferably the amount of saccharide, disaccharides (other than sucralose), and corn syrup solids levels, are each no more than 2 wt-%, preferably each no more than 1 wt-%, more preferably each no more than 0.6, wt-%, even more preferably each no more than 0.5 wt-%, most preferably 0 wt-%, based on total weight of the composition.

In general, two preferred types of compositions are defined, one comprising a low fat formulation and one comprising an ultra low fat formulation. In general, the low fat formulation includes several times more oil/fat component, than the ultra low composition. Preference among the consumers between the two, will relate to individual preferences regarding such factors of nutrition, product mouth feel, and flavor. It has been observed, however, that the presence of the sucralose helps make the ultra low fat composition more viable than might have been expected, because the sucralose will, to a certain extent, make up for the reduction in desirable mouth feel due to a very low oil/fat level. In general, some oil/fat is desirable (typically at least 1 wt-%), to enhance flavor distribution.

Some preferred compositions are provided in the following Table.

Low Fat/Ultra Low Fat Compositions

| | | | Wt-%¹ in | Wt-%¹ in | Example⁴ | Example⁵ |
|---|---|---|---|---|---|---|
| | Typical | Typical | Preferred | Preferred | (grams per | (grams |
| | Wt.-%¹ | Wt.-%¹ | Composition | Composition | bag) Low | per bag) |
| | Low or | Ultra | Low or | Ultra Low | or Light | Ultra Low |
| Ingredient | Light Fat | Low Fat | Light Fat | Fat | Fat | Fat |
| Unpopped | 83-90 | 93-95 | 83-87 wt-% | 94-95 | (g/bag) | (g/bag) |
| Popcorn | wt-% | wt-% | | wt-% | 72.00 | 80.00 |
| Oil/Fat | 7-14 | 1.5-4.0 | 11-13 | 1.5-2.8 wt-% | 10.00 | 3.00 |
| | wt-% | wt-% | wt-% | | | |
| Salt (NaCl) | 2-4 wt-% | 1.75-2.75 | 2.0-3.5 | 2.0-2.5 wt-% | 2.90 | 1.85 |
| | | wt-% | wt-% | | | |
| Sucralose | 0.03-0.3 | 0.03-0.3 | .02-0.2 | .02-0.2 | 0.06 | 0.07 |
| | wt-% | wt-% | wt-% | | | |
| Mono- | <1 wt-% | <1 wt-% | <0.5 wt-%, | <0.5 wt-%, | 0 | 0 |
| saccharides² | | | preferably 0 | preferably 0 | | |
| Sugar³ | <1 wt-% | <1 wt-% | <0.5%, | <0.5 wt-%, | 0 | 0 |
| | | | preferably 0 | preferably 0 | | |
| Corn Syrup | <1 wt-% | <1 wt-% | <0.5%, | <0.5 wt-%, | 0 | 0 |
| Solids | | | preferably 0 | preferably 0 | | |

¹Based on total weight of unpopped popcorn composition, including popcorn, oil/fat, and flavor additives.
²The term “monosaccharides”includes dextrin and dextrin derivatives such as maltodextrin.
³The term “sugar”means disaccharides (other than sucralose).
⁴About an 85 gram composition, having 72 grams of unpopped popcorn, is provided in a typical single microwave popcorn bag for a low fat composition.
⁵About an 85 gram composition, having 80 grams of unpopped popcorn, is provided in a typical single bag for an ultra low fat composition.

As in the parent, the term “oil/fat” and variants thereof refer to materials that are primarily tri-fatty acid esters of glycerol. Fat is a natural lipid material that is temperature. The term “oil/fat component” is meant to refer to oil(s), fat(s) (natural or modified) and any mixtures thereof. The “oil/fat component” may be a solid, liquid, or semi-solid at room temperature.

With respect to the reduced fat compositions, again the key flavor components are the unpopped popcorn, the salt (sodium chloride) and the sucralose. Also in many instances, the preferred ratios of these components to one another, are within, or overlap, the ratios derivable from the parent disclosure in connection with the compositions disclosed therein.

More specifically:

(a) in general, for reduced fat compositions, the weight ratio of salt to unpopped popcorn is typically within the range of 0.5/98 to 5/80 or 0.005-0.0625; for the “low fat” the ratio is typically within the range of 2/90 to 4/83 or 0.022-0.048; for the ultra low fat, the ratio is typically within the range of 1.75/95-2.75/93 or 0.018-0.030.

(b) in general, for reduced fat compositions, the weight ratio of sucralose to salt is typically within the range of 0.01/5 to 0.5/0.5 or 0.002-1.0; for the “low fat” the ratio is typically within the range of 0.03/4 to 0.3/2 or 0.0075-0.15; and, for the “ultra low fat” the ratio is typically within the range of 0.03/2.75-0.3/1.75 or 0.01-0.17; and,

(c) in general, for reduced fat compositions, the weight ratio of sucralose to unpopped popcorn is typically within the range of 0.01/98-0.5/80 or 0.00102-0.00625; typical “low fat” compositions would have a ratio within the range of 0.03/90-0.3/83 or 0.0003-0.0036; and typical “ultra low fat” compositions would have a ratio within the range of 0.03/95-0.3/93 or 0.0003-0.0032.

As with the parent formulations, additional flavorings can be provided if desired. For example flavors such as butter flavor, vanilla flavor, sweet butters/creams, cinnamon, fruit flavors, chocolates/cocas, maples, nut flavors/peanut butter, caramels, molasses, brown sugars, cotton candy, cookie flavors/graham crackers, sweet BBQ’s, honeys, marshmallow, butterscotch, toffees, licorice, mints, sweet alcohol flavors, sweet vegetable flavors (e.g., sweet potato, sweet corn), coffee, tea, pop/soda beverage flavors (e.g., cola, root beer, cream soda, etc.), citric flavors, dressing and condiment flavors, dairy flavors (e.g., milk, yogurt, sweet cheeses), ethnic savory/sweet combinations (e.g., sweet chilies). As with the parent application, it is important in selecting a flavor component that materials which exacerbate the burn problem, for example disaccharides, monosaccharides and corn syrup solids, are avoided to any significant extent. Further the amounts of the flavor should be used in no more than a minimum effective amount to accomplish the level of flavor or color desired. In general the amount will be sufficiently low, as not to affect the stated ratios and preferred percent ranges, for the key flavor components. In typical situations, the flavor would be added, with a concommitant reduction in the amount of the oil/fat component.

Colors can be added. Generally, they are disregarded herein, as long as they are selected from materials that do not interfere with the flavor components.

### IV. EXPERIMENTAL

A. Experiments from the Parent Application.

In the following experiments, evaluations are made of sucralose alone and in combination with other natural sweetening agents to sweeten microwave popcorn; and, the effects of adding salt in combination with sucralose and/or other natural sweetening agents to develop a sweet and salty flavor in microwave popcorn.

### PROCEDURE

The experiments reported below were conducted in accordance with the following general procedure:

The hydrogenated oil was melted and weighed in glass beaker to provide the amount indicated. The designated dry ingredients were added to the melted oil and mixed until thoroughly incorporated and suspended evenly in the oil. The unpopped popcorn was weighed on a balance and placed in a popcorn bag. The oil mixture was then poured into the bag and the bag was sealed. The popcorn bags used were conventional microwave popcorn paper bags having a microwave interactive susceptor in the bottom of the bag. Such a bag is used (for example, in the 2000-2001 time period) in the commercially available product Act II Natural Microwave popcorn.

The filled popcorn bag was popped in a typical consumer microwave oven, specifically, a 1100 watt GE turntable microwave oven—(Model number: JES 1231IWC 001). The cook time used was typical for microwave popcorn used in this type of microwave oven, 1.40 minutes +-−5 seconds.

The various ingredients used in the formulations were obtained from the following suppliers:

Sugar (powdered and granulated), from C&H Sugar, 1 California Street, San Francisco, Calif. 94111; and from Karp's, 14675 Martin Dr., Eden Prairie, MN 55344.

Partially Hydrogenated Soybean Oil, from ADM; Box 1470; Decatur, Ill. 82526 (Supplier Code: 86-569-0); from Central Soya, 1946 West Cook Road, PO Box 1400, Fort Wayne, Ind. 46801-1400, (Supplier Code: SHO-29); from AC Humko, 7171 Goodlett Farms Pkwy, PO Box 343, Memphis, Tenn. 38018, (Supplier Code: F01527); and from Bunge Corporation, 11720 Borman Drive, PO Box 28500, St. Louis, Mo. 63146, (Supplier Code: I0089-F914x).

Sucralose, under the trade designation “Splenda” brand, from McNeil Specialty Products Co., 501 George Street P.O. Box 2400, New Brunswick, N.J. 08903-2400.

Salt, under the trade designation “Morton 200 Extra Fine Salt” and “Morton TC999”, from Morton International, 100 North Riverside Plaza, Chicago, Ill. 60606-1597. Essentially all of the Morton 200 Extra Fine Salt passed through a 100 U.S. sieve. Specifically, the salt was classified as follows: U.S. sieve 100, trace; sieve 200, 3%; 325 sieve, 22%; 400 sieve, none; pan, 75%.

Maltodextrins, Corn Syrup Solids, Modified Food Starches, under the trade designations “Maltrin” QD-M600, M050, M180, “PureCote-B790”, from Grain Processing Corporation, Muscatine, Iowa 52761-1494.

Experiment 1

For Experiment 1, the popcorn composition included common sweetening additives, but no added salt.

| Ingredient | g/bag |
|---|---|
| Formulation 1A | |
| Popcorn | 66.00 |
| Hydrogenated Soybean Oil | 32.00 |
| Corn Syrup Solids (Maltrin QD-M600) | 1.00 |
| Comments: Popped popcorn had slight sweet taste. Popped popcorn had no burnt taste. No burning on inner package wall occurred during cooking. | |
| Formulation 1B | |
| Popcorn | 66.00 |
| Hydrogenated Soybean Oil | 32.00 |
| Maltodextrin (M050) | 1.00 |
| Comments: Popped popcorn had very slight sweet taste. Popped popcorn had no burnt taste. No burning on inner package wall occurred during cooking. | |
| Formulation 1C | |
| Popcorn | 66.00 |
| Hydrogenated Soybean Oil | 32.00 |
| Maltodextrin (M180) | 1.00 |
| Comments: Popped popcorn had very slight to slight sweet taste. Popped popcorn had no burnt taste. No burning on inner package wall occurred during cooking. | |
| Formulation 1D | |
| Popcorn | 66.00 |
| Hydrogenated Soybean Oil | 32.00 |
| Modified Food Starch (Pure Cote-B790) | 1.00 |
| Comments: Popped popcorn had no detectable sweet taste. Popped popcorn had no burnt taste. No burning on inner package wall occurred during cooking. | |
| Formulation 1E | |
| Popcorn | 66.00 |
| Hydrogenated Soybean Oil | 32.00 |
| Sugar (granulated; from C&H) | 1.00 |
| Comments: Popped popcorn had very slight sweet taste. Popped popcorn had no burnt taste. No burning on inner package wall occurred during cooking. | |
| Formulation 1F | |
| Popcorn | 66.00 |
| Hydrogenated Soybean Oil | 32.00 |
| Sugar (powdered; C&H) | 1.00 |

Comments: Popped popcorn had very slight sweet taste. Popped popcorn had no burnt taste. No burning on inner package wall occurred during cooking.

Conclusions from Formulations 1A through 1F:

The sweetening agents used in formulations 1A through 1F at 1gram/bag showed no signs of burning on the popcorn or interior surface of the microwave popcorn bag. Overall, these sweetening agents delivered a low sweetness intensity. The granular and powdered sugar had the highest sweetness intensity, followed by corn syrup solids. Maltodextrin and modified food starch contributed little to sweetness.

Experiment 2

For Experiment 2, the popcorn compositions were similar to Experiment 1, except that Experiment 2 included common sweetening additives with some added salt.

| Ingredient | g/bag |
|---|---|
| Formulation 2A | |
| Popcorn | 66.00 |
| Hydrogenated Soybean Oil | 31.50 |
| Corn Syrup Solids (Maltrin QD-M600) | 1.00 |
| Salt (Morton-200 Fine) | 0.5 |
| Comments: After cooking the popped popcorn had a slight bitter/burnt taste. A large number of burnt particles on the inner package. Large burn score on the inner package wall, approximately 1.5″ × 1.5″ in size. | |
| Formulation 2B | |
| Popcorn | 66.00 |
| Hydrogenated Soybean Oil | 31.50 |
| Maltodextrin (M050) | 1.00 |
| Salt (Morton-200 Fine) | 0.5 |
| Comments: After cooking the popped popcorn had a slight bitter/burnt taste. A small number of burnt particles on popped popcorn product and on the inner package wall. | |
| Formulation 2C | |
| Popcorn | 66.00 |
| Hydrogenated Soybean Oil | 31.50 |
| Maltodextrin (M180) | 1.00 |
| Salt (Morton-200 Fine) | 0.5 |
| Comments: After cooking the popped popcorn had a slight bitter/burnt taste. A large number of burnt particles on popped popcorn product and on the inner package wall. | |
| Formulation 2D | |
| Popcorn | 66.00 |
| Hydrogenated Soybean Oil | 31.50 |
| Modified Food Starch (Pure Cote-B790) | 1.00 |
| Salt (Morton-200 Fine) | 0.5 |
| Comments: Popped popcorn had a slight bitter/burnt taste. A small number of burnt particles on cooked product and on the inner package wall. | |
| Formulation 2E | |
| Popcorn | 66.00 |
| Hydrogenated Soybean Oil | 31.50 |
| Sugar (granulated; from C&H) | 1.00 |
| Salt (Morton-200 Fine) | 0.5 |
| Comments: Popped popcorn had a slight bitter or burnt taste. Dark browning over susceptor area on inner package wall. | |
| Formulation 2F | |
| Popcorn | 66.00 |
| Hydrogenated Soybean Oil | 31.50 |
| Sugar (powdered; from C&H) | 1.00 |
| Salt (Morton-200 Fine) | 0.5 |

Comments: Popped popcorn had a slight bitter or burnt taste. Dark browning over susceptor area on inner package wall.

Conclusions from formulations 2A through 2F:

Compared to formulations 1A through 1F, the popped popcorn of formulations 2A through 2F developed a slight bitter flavor when enough salt was added to cause a significant salt taste. Burning occurred on the inner package wall during cooking. The burning decreased sweetness intensity of the sweetening agents.

Experiment 3

For Experiment 3, the popcorn compositions were similar to Experiment 1, except that Experiment 3 included sucralose in combination with the common sweetening additives, and with no added salt.

| Ingredient | g/bag |
|---|---|
| Formulation 3A | |
| Popcorn | 66.00 |
| Hydrogenated Soybean Oil | 31.90 |
| Corn Syrup Solids (Maltrin QD-M600) | 1.00 |
| Sucralose | 0.1 |
| Comments: The popped popcorn had a slight bitter/burnt taste and slight to medium sweet taste. A large number of burnt particles were on the inner package wall. Large burn score on the inner package wall, approximate 3.5″ × 2.5″. | |
| Formulation 3B | |
| Popcorn | 66.00 |
| Hydrogenated Soybean Oil | 31.90 |
| Maltodextrin (M050) | 1.00 |
| Sucralose | 0.1 |
| Comments: The popped popcorn had a slight bitter/burnt taste and a slight to medium sweet taste. A small number of burnt particles were on the cooked product and on the inner package wall. | |
| Formulation 3C | |
| Popcorn | 66.00 |
| Hydrogenated Soybean Oil | 31.90 |
| Maltodextrin (M180) | 1.00 |
| Sucralose | 0.1 |
| Comments: The popped popcorn had a slight bitter/burnt taste and a slight to medium sweet taste. A large number of burnt particles were on the cooked product and on the inner package wall. | |
| Formulation 3D | |
| Popcorn | 66.00 |
| Hydrogenated Soybean Oil | 31.90 |
| Modified Food Starch (Pure Cote-B790) | 1.00 |
| Sucralose | 0.1 |
| Comments: The popped popcorn had a slight bitter/burnt taste and a slight to medium sweet taste. A small number of burnt particles were on the cooked product and on the inner package wall. | |
| Formulation 3E | |
| Popcorn | 66.00 |
| Hydrogenated Soybean Oil | 31.90 |
| Sugar (granulated; from C&H) | 1.00 |
| Sucralose | 0.1 |
| Comments: The popped popcorn had a slight bitter/burnt taste and a slight to medium sweet taste. A small number of burnt particles were on the cooked product and on the inner package wall. Blackened spots were on the inner package wall over the susceptor area. | |
| Formulation 3F | |
| Popcorn | 66.00 |
| Hydrogenated Soybean Oil | 31.90 |
| Sugar (powdered; from C&H) | 1.00 |
| Sucralose | 0.1 |

Comments: The popped popcorn had a slight bitter/burnt taste and a slight to medium sweet taste. A small number of burnt particles were on the cooked product and on the inner package wall. Blackened spots were on the inner package wall and over the susceptor area.

Conclusion from Formulations 3A through 3F:

Compared to formulations 1A through iF, a slight bitter/burnt flavor developed and burning occurred on the inner package wall during cooking of the popcorn for formulations 3A through 3F that had sucralose. The addition of sucralose to formulations 1A and 1F contributed a slight to medium sweet flavor that was even detectable over the bitter/burnt flavor.

Experiment 4

For Experiment 4, sucralose was the only sweetener added, and there was no added salt.

| Ingredient | g/bag |
|---|---|
| Formulation 4A | |
| Popcorn | 66.00 |
| Hydrogenated Soybean Oil | 33.00 |
| Sucralose | 0.001 |
| Comments: Popped popcorn had no perceptible sweet taste. No burnt taste. No burning on inner package wall occurred during cooking. | |
| Formulation 4B | |
| Popcorn | 66.00 |
| Hydrogenated Soybean Oil | 32.99 |
| Sucralose | 0.01 |
| Comments: Popped popcorn had a slight sweet taste. No burnt taste. No burning on inner package wall occurred during cooking. | |
| Formulation 4C | |
| Popcorn | 66.00 |
| Hydrogenated Soybean Oil | 32.94 |
| Sucralose | 0.06 |
| Comments: Popped popcorn had an acceptable sweet taste. No burnt taste. No burning on inner package wall occurred during cooking. | |
| Formulation 4D | |
| Popcorn | 66.00 |
| Hydrogenated Soybean Oil | 32.91 |
| Sucralose | 0.09 |
| Comments: Popped popcorn had an acceptable sweet taste. No burnt taste. No burning on inner package wall occurred during cooking. | |
| Formulation 4E | |
| Popcorn | 66.00 |
| Hydrogenated Soybean Oil | 32.90 |
| Sucralose | 0.10 |
| Comments: Popped popcorn had an acceptable sweet taste. A large number of burnt particles were on the cooked product and the inner package susceptor area. | |
| Formulation 4F | |
| Popcorn | 66.00 |
| Hydrogenated Soybean Oil | 32.82 |
| Sucralose | 0.18 |
| Comments: Popped popcorn had a strong sweet taste. A very large number of burnt particles on cooked popcorn and on the inner package wall, concentrated on the susceptor area. | |
| Formulation 4G | |
| Popcorn | 66.00 |
| Hydrogenated Soybean Oil | 32.50 |
| Sucralose | 0.50 |

Comments: Popped popcorn had a strong/intense sweet taste, too intense. An extreme number of burnt particles on cooked popcorn and on the inner package wall, concentrated on the susceptor.

Conclusions from formulations 4A through 4G:

Formulations 4A through 4G were formulated with different levels of sucralose and without additional sweetening agents. Sucralose has a minimum and maximum level at which it can be used without having a negative impact on the popped popcorn. At levels of 0.01 to 0.10 gram per bag (based on popcorn composition content of 99 grams) the product has an acceptable sweetness and acceptable amount of burnt particles on the inner package wall and product. Above 0.10 gram sucralose per bag (based on popcorn composition content of 99 grams) the popped product has an unacceptable level of burnt particles on the inner package wall, as well as an unacceptable level of burnt particles on the popped popcorn.

Experiment 5

For Experiment 5, the popcorn compositions were similar to Experiment 4, except that Experiment 5 used sucralose with some added salt.

| Ingredient | g/bag |
|---|---|
| Formulation 5A | |
| Popcorn | 66.00 |
| Hydrogenated Soybean Oil | 32.46 |
| Sucralose | 0.040 |
| Salt (Morton-200 fine) | 0.500 |
| Comments: No burning of popcorn or packaging. No burnt taste. Mild sweet impact throughout, no salt taste detected. | |
| Formulation 5B | |
| Popcorn | 66.00 |
| Hydrogenated Soybean Oil | 31.96 |
| Sucralose | 0.04 |
| Salt (Morton-200 fine) | 1.00 |
| Comments: No burning of popcorn or packaging. No burnt taste. Mild sweet flavor and mild salty flavor, both balanced. Acceptable for commercial product. | |
| Formulation 5C | |
| Popcorn | 66.00 |
| Hydrogenated Soybean Oil | 31.46 |
| Sucralose | 0.04 |
| Salt (Morton-200 fine) | 1.50 |
| Comments: No burning of popcorn or packaging. No burnt taste. Sweet flavor upfront, mild to acceptable impact. Stronger salty flavor at end. | |
| Formulation 5D | |
| Popcorn | 66.00 |
| Hydrogenated Soybean Oil | 30.96 |
| Sucralose | 0.04 |
| Salt (Morton-200 fine) | 2.0 |
| Comments: No burning of popcorn or packaging. No burnt taste. Strong salty flavor, starting to overpower sweet flavor impact. | |
| Formulation 5E | |
| Popcorn | 66.00 |
| Hydrogenated Soybean Oil | 30.46 |
| Sucralose | 0.04 |
| Salt (Morton-200 fine) | 2.50 |
| Comments: No burning of popcorn or packaging. No burnt taste. Unacceptable salty flavor, no sweet flavor. | |
| Formulation 5F | |
| Popcorn | 66.00 |
| Hydrogenated Soybean Oil | 29.96 |
| Sucralose | 0.04 |
| Salt (Morton-200 fine) | 3.00 |
| Comments: No burning of popcorn or packaging. No burnt taste. Unacceptable salty flavor, no sweet flavor. | |
| Formulation 5G | |
| Popcorn | 66.00 |
| Hydrogenated Soybean Oil | 29.46 |
| Sucralose | 0.04 |
| Salt (Morton-200 fine) | 3.5 |

Comments: No burning of popcorn or packaging. No burnt taste. Unacceptable salty flavor, no sweet flavor.

Conclusions from Formulations 5A through 5G:

Formulations 5A through 5G were formulated with different levels of salt while maintaining the same level of sucralose. At all levels tested there was no burning of the popcorn or of the packaging. The combination of sucralose and salt in a microwave popcorn product can be used together without a negative physical effect on the popcorn or packaging. The preferred sucralose level based on a popcorn composition of 99 grams total (where the popcorn is 66 grams) is about 0.04 gram per bag, when combined with salt at levels of 1 -1.5 grams salt per bag. At theses salt levels, the product has an acceptable range of sweet and salty flavor combination characteristic of the product. The percentage ratio of salt to sucralose in a preferred formula would typically be about 96.2 wt-% salt and 3.8 wt-% sucralose to about 97.4 wt-% salt and 2.6 wt-% sucralose, with a preferred percentage of about 97.5 wt-% salt to 2.5 wt-% sucralose.

General Conclusions from Experiments

Natural sweeteners like sugar (sucrose), maltodextrins and corn syrup solids have the ability to sweeten microwave popcorn without contributing any bitter/burnt flavors from the microwave cooking process. However, if a product is formulated containing both a natural sweetener and a minimum amount of salt, the popped popcorn and inner package walls exhibit an unacceptable level of burning. This burning provides an unacceptable taste to the product.

However, when sucralose is used as the sweetening agent in salted microwave popcorn formulations, an acceptable level of sweetness is achieved, as is an extremely low level of burnt particles on the popped popcorn. A microwave popcorn formulation that contains both salt and sucralose, the sucralose being at least of 0.01 gram per bag and not more than 0.1 gram per bag (based on a bag with 99 grams of charge, of which 66 grams is popcorn), has acceptable sweet and salty flavor. Formulations having a natural sweetener added to the combination of sucralose and salt tend to exhibit an unacceptable level of burning on the inner package wall and on the popped popcorn.

To formulate a sweet and salty microwave popcorn, the preferred formulation is a combination of sucralose and salt without the other natural sweeteners, at least at the levels tested. The preferred level of sucralose is no less than 0.01 gram/bag and no more than 0.10 gram/bag, based on a 99 grams composition that has 66 grams popcorn. The sucralose can be present at a level of at least 0.02 wt-% of the popcorn composition.

B. Sample Compositions of Reduced Fat
Sweet and Salty Microwave Popcorn

| Ingredient | grams per bag | wt.-% |
|---|---|---|
| Sample 1: | | |
| Corn | 80.50 | 94.15 |
| Oil¹ | 2.86 | 3.34 |
| Salt² | 2.01 | 2.36 |
| Sucralose | 0.09 | 0.10 |
| Butter Flavor³ | 0.04 | 0.05 |
| TOTAL | 85.50 | 100.00 |
| Sample 2: | | |
| Corn | 80.50 | 94.15 |
| Oil | 2.56 | 3.00 |
| Salt | 2.00 | 2.34 |
| Sucralose | 0.09 | 0.10 |
| Butter Flavor | 0.35 | 0.41 |
| TOTAL | 85.50 | 100.00 |
| Sample 3: | | |
| Corn | 80.50 | 94.15 |
| Oil | 2.90 | 3.39 |
| Salt | 2.04 | 2.39 |
| Sucralose | 0.06 | 0.07 |
| TOTAL | 85.50 | 100.00 |
| Sample 4: | | |
| Corn | 80.50 | 94.15 |
| Oil | 3.42 | 4.01 |
| Salt | 1.50 | 1.75 |
| Sucralose | 0.08 | 0.09 |
| TOTAL | 85.50 | 100.00 |

¹The oil would be, for example, a partially hydrogenated soybean oil.
²The salt would be, for example, Morton 200.
³The butter flavor would be, for example, natural and artificial, oil dispersable butter flavor as would be typical of microwave popcorn. These can be obtained from such suppliers as International Flavors and Fragrances, Dayton, NJ or Givaudan Flavors Corp., Cincinnati, OH.

We claim:

1. A microwaveable popcorn composition which, upon popping, provides a popped popcorn product having a sweet and salty taste; said popcorn composition comprising:
(a) unpopped popcorn;
(b) oil/fat component;
(c) salt, present at a level of at least 0.5 g per 66 gram popcorn; and,
(d) a sweetening effective amount of sucralose.

2. A composition according to claim 1 wherein:
(a) the sucralose is present at a weight ratio with respect to the salt, within the range of 0.005-0.625.

3. A composition according to claim 2 wherein:
(a) the sucralose is present at a weight ratio, with respect to the unpopped popcorn kernels, within the range of 0.00017-0.00909.

4. A composition according to claim 3 wherein the composition comprises:
(i) less than 1 wt-% monosaccharides; if any;
(ii) less than 1 wt-% non-sucralose disaccharides, if any; and, (iii) less than 1 wt-% corn syrup solids, if any.

5. A composition according to claim 1 including:
(a) no more than 20 wt-% oil/fat component.

6. A composition according to claim 5 including:
(a) no more than 15 wt-% oil/fat component.

7. A composition according to claim 1 including:
(a) 1-15 wt-% oil/fat component.

8. A composition according to claim 1 including:
(a) 80-98 wt-%, unpopped popcorn kernels;
(b) 0.5-5.0 wt-%, salt;
(c) 0.01-0.5 wt-%, sucralose;
(d) less than 1 wt-% monosaccharides, if any;
(e) less than 1 wt-% non-sucralose disaccharides, if any; and, (f) less than 1 wt-% corn syrup solids, if any.

9. A composition according to claim 8 including:
(a) 83-90 wt-%, unpopped popcorn kernels;
(b) 7-14 wt-%, oil/fat component;
(c) 2-4 wt-%, salt; and,
(d) 0.03-0.3 wt-%, sucralose.

10. A composition according to claim 9 including:
(a) 83-87 wt-%, unpopped popcorn kernels;
(b) 11 - 13 wt-%, oil/fat component;
(c) 2.0-3.5 wt-%, salt;
(d) 0.02-0.2 wt-%, sucralose;
(e) less than 0.5 wt-%, monosaccharides, if any;
(f) less than 0.5 wt-%, non-sucralose disaccharides, if any; and,
(g) less than 0.5 wt-%, corn syrup solids, if any.

11. A composition according to claim 8 including:
(a) 93-95 wt-%, unpopped popcorn kernels;
(b) 1.5-4.0 wt-%, oil/fat component;
(c) 1.75-2.75 wt-%, salt; and,
(d) 0.03-0.3 wt-%, sucralose.

12. A composition according to claim 11 including:
(a) 94-95 wt-%, unpopped popcorn kernels;
(b) 1.5-2.8 wt-%, oil/fat component;
(c) 2.0-2.25 wt-%, salt;
(d) 0.02-0.2 wt-%, sucralose;
(e) less than 0.5 wt-%, monosaccharides, if any;
(f) less than 0.5 wt-%, non-sucralose disaccharides; if any; and
(g) less than 0.5 wt-%, corn syrup solids, if any.

13. A microwaveable popcorn composition consisting essentially of:
(a) 80-98 wt-%, unpopped popcorn kernels;
(b) 1- 15 wt-%, oil/fat component; and
(c) flavor component comprising:
(i) 0.5-5.0 wt-%, salt based on total weight of popcorn composition;
(ii) 0.01-0.15 wt-%, sucralose, based on total weight of popcorn composition.

14. A composition according to claim 13 wherein:
(a) said flavor component further includes butter flavor.

15. A composition according to claim 13 consisting essentially of:
(a) 83-90 wt-%, unpopped popcorn kernels;
(b) 7-14 wt-%, oil/fat component; and
(c) flavor component comprising:
(i) 2-4 wt-%, salt; and,
(ii) 0.03-0.3 wt-%, sucralose.

16. A composition according to claim 13 consisting essentially of:
(a) 93-95 wt-%, unpopped popcorn kernels;
(b) 1.5-4.0 wt-%, oil/fat component;
(c) flavor component comprising:
(i) 1.75-2.75 wt-% salt based on total weight of popcorn composition; and,
(ii) 0.03-0.3 wt-%, sucralose.

17. A microwave popcorn product comprising:
(a) a container suitable for use in a microwave popcorn popping process; and,
(b) a microwave popcorn composition positioned inside the container and comprising:
(i) unpopped popcorn kernels;
(ii) no more than 15 wt-%, oil/fat component;
(iii) salt at a level of at least 0.5 grams per 66 grams of popcorn; and,
(iv) a sweetening effective amount of sucralose.

18. A microwave popcorn product according to claim 17 wherein:
(a) said microwave popcorn composition includes:
(i) 80-98 wt-%, unpopped popcorn kernels;
(ii) 1- 15 wt-%, oil/fat component;
(iii) 0.5-5.0 wt-%, salt;
(iv) 0.01-0.5 wt-%, sucralose;
(v) less than 1 wt-% monosaccharides, if any;
(vi) less than 1 wt-% non-sucralose disaccharides, if any; and
(vii) less than 1 wt-% corn syrup solids, if any.

19. A product according to claim 18 wherein:
(a) the container is a two-ply bag construction with a microwave interactive construction positioned between an inner ply and an outer ply.

20. A product according to claim 18 wherein:
(a) the container is a fiberboard tub.

21. A microwaveable popcorn composition which, upon popping, provides a popped popcorn product having a sweet and salty taste; said popcorn composition comprising:
(a) unpopped popcorn;
(b) oil/fat component;
(c) salt; and
(d) sucralose:
(i) the weight ratio of salt to unpopped popcorn kernels being within the range of 0.0121-0.0364; and
(ii) the weight ratio of sucralose to salt being within the range of 100.005-0.625.
